(19) United States
(12) Patent Application Publication
(10) Pub. No.: US 2026/0300689 A1
(43) Pub. Date: Oct. 1, 2026

(54) ARTIFICIAL INTELLIGENCE FOR COGNITIVE INTERFACES

(71) Applicant: SAP SE, Walldorf (DE)

(72) Inventor: Ramalingam TV, Calgary (CA)

(21) Appl. No.: 19/097,056

(22) Filed: Apr. 1, 2025

(51) Int. Cl. G06N 3/045; G06F 3/01

(52) U.S. Cl. CPC G06N 3/045; G06F 3/015

(57) ABSTRACT

In an example embodiment, a machine learning framework is provided that enhances reliability of analysis of non-invasive cognitive input, correlates the cognitive input with additional non-cognitive input, and identifies context-based possible selections from software processes. A graphical user interface may be provided that depicts the possible selections to the user in a manner that makes it clear to the user which thoughts lead to which selections. This graphical user interface may be iteratively updated with each selection by the user, with each selection leading to one or more possible selections displayed in the graphical user interface being replaced with different possible selections. The result is a seamless framework that aids in enhancing cognitive interfaces.

### CROSS-REFERENCE TO RELATED APPLICATIONS

This application is related to US Application titled, Artificial Intelligence-Based Dynamic Operation Dialer, Docket No. 2058.H59US1, being filed on ______ as US Application No. ______, which is incorporated by reference herein in its entirety.

### TECHNICAL FIELD

This document generally relates to computer systems. More specifically, this document relates to artificial intelligence for cognitive interfaces.

### BACKGROUND

A cognitive interface is a user interface in which a user's brain activity is used as input to a computer system. Various sensors may be used to track and monitor brain activity, and signals from these sensors may then be used to control aspects of a computer system, in the same way that a user may provide input in the form of keyboard input, mouse input, touchpad/touchscreen input, voice input, etc. The big advantage of cognitive interfaces is that they do not require movement by the user.

### BRIEF DESCRIPTION OF THE DRAWINGS

The present disclosure is illustrated by way of example and not limitation in the figures of the accompanying drawings, in which like references indicate similar elements.

FIG. 1 is a block diagram illustrating a system for providing a cognitive input framework, in accordance with an example embodiment.

FIG. 2 is a block diagram illustrating a system for using machine learning to manage cognitive input, in accordance with an example embodiment.

FIG. 3 is a block diagram illustrating the deep learning orchestration base of FIG. 2 in more detail.

FIG. 4 is a block diagram illustrating the polysift layer of FIG. 2 in more detail.

FIG. 5 is a block diagram illustrating a pre-datasift layer and a datasift layer of FIG. 2 in more detail.

FIG. 6 is a block diagram illustrating the post-datasift layer and the enterprise operation dialer of FIG. 2 in more detail, in accordance with an example embodiment.

FIG. 7 is a diagram illustrating an example graphical user interface, in accordance with an example embodiment.

FIG. 8 is a diagram illustrating an example graphical user interface having specific values for entities and steps, in accordance with an example embodiment.

FIG. 9 is a flow diagram illustrating a method for processing signals from one or more cognitive interfaces, in accordance with an example embodiment.

FIG. 10 is a flow diagram illustrating a method for generating a user interface, in accordance with an example embodiment.

FIG. 11 is a block diagram illustrating a software architecture, in accordance with an example embodiment.

FIG. 12 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

Traditional means of measuring brain activity in a non-invasive manner, such as by using electroencephalogram sensors affixed to skin of the head, are not precise enough to provide a robust user interface. Efforts to provide more accurate cognitive interfaces generally have focused on more invasive techniques, such as surgical techniques to implant sensors under the scalp or even inside the brain itself, but these techniques are in their early stages and most users would not wish to undergo invasive procedures to provide such a cognitive interface. As such, what is needed is a system that provides a more accurate cognitive interface while still utilizing non-invasive sensors.

In an example embodiment, a machine learning framework is provided that enhances reliability of analysis of non-invasive cognitive input, correlates it with additional non-cognitive input, and identifies context-based possible selections from software processes. A graphical user interface may be provided that depicts the possible selections to the user in a manner that makes it clear to the user which thoughts lead to which selections. This graphical user interface may be iteratively updated with each selection by the user, with each selection leading to one or more possible selections displayed in the graphical user interface being replaced with different possible selections. The result is a seamless framework that aids in enhancing cognitive interfaces.

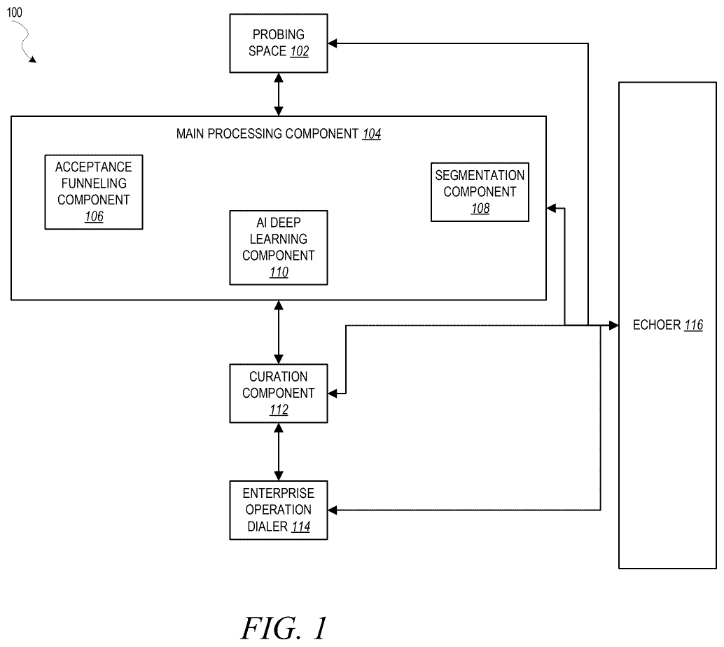

FIG. 1 is a block diagram illustrating a system 100 for providing a cognitive input framework, in accordance with an example embodiment. Data input and initial processing takes place in a probing space 102. Here, input is received and basic manipulation and enriching is performed. At a main processing component 104, an acceptance funneling component 106 funnels cognitive acceptance input into appropriate buckets, and a segmentation component 108 segments the input according to the entity (the user or user's organization) and software process the user is attempting to influence.

An artificial intelligence (AI) deep learning component 110 includes a pretrained model for all data sets. This is where the machine learning processing, deep learning processing, and other artificial intelligence processing is performed.

A curation component 112 retrieves the connections between selections and steps/selections of a software process, as well as provides insights about how the model is performing and what the user is trying to receive. It determines how the process flow should look and determines which thoughts translate to which aspects of the process flow.

An enterprise operation dialer 114 acts as a graphical user interface, which is populated with possible selections the user can make based on cognitive input. The enterprise operation dialer 114 will be described in more detail below.

An echoer 116 is a central space that interacts with other components to listen to all interactions. It validates the information, understands what is happening and sees if there is a deviation. If there is, the echoer 116 sends it on to a respective error layer and conformance layer for every process. The error layer identifies the error, and the conformance layer validates after the error is corrected.

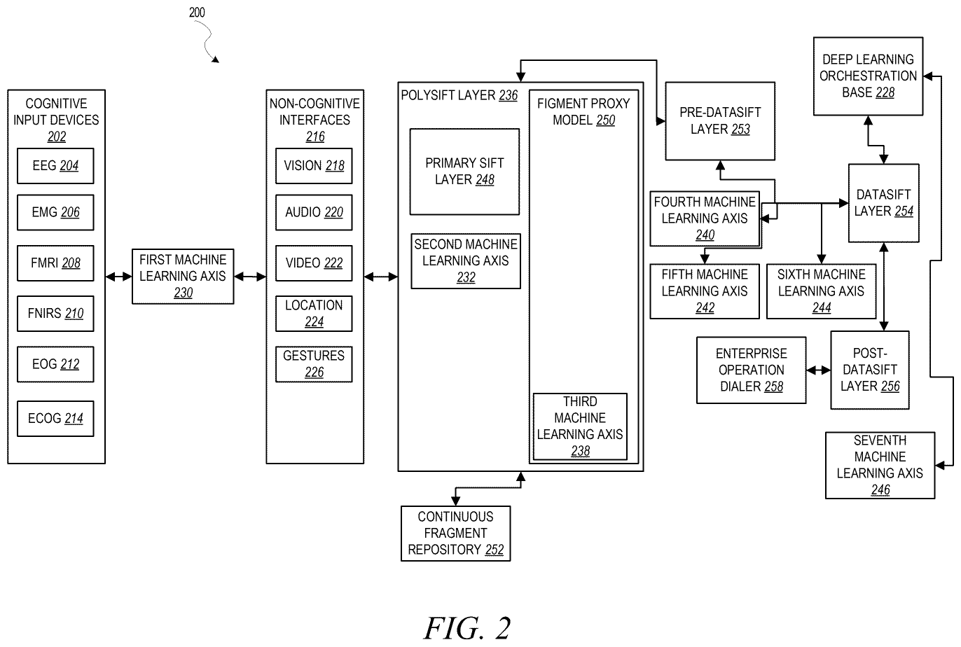

FIG. 2 is a block diagram illustrating a system 200 for using machine learning to manage cognitive input, in accordance with an example embodiment. Depicted here are a plurality of different types of cognitive input devices 202. These include, but are not limited to, electroencephalogram (EEG) 204, electromyography (EMG) 206, functional magnetic resonance imaging (fMRI) 208, functional near-infrared spectroscopy (fNIRS) 210, electrooculogram (EOG) 212, and electrocorticography (ECoG) 214.

EEG 204 involves using sensors to record electrical signals of the brain. EMG 206 measures muscle response or electrical activity in response to a nerve's stimulation of the muscle. FNIRS 210 is a non-invasive brain imaging technique that uses infrared light to measure blood flow changes in the brain. EOG 212 is a technique that measures the electrical potential between the front and back of the eye. Electrodes are placed near the eyes to record the signal produced by eye movements. ECOG 214 is a type of electrophysiological monitoring that involves placing electrodes on the brain to record electrical activity.

It should be noted that while more than one type of cognitive input devices 202 are depicted here, there is no requirement than more than one cognitive input device 202 be used or even provided in the system 200. The cognitive input devices 202 depicted here are merely examples of types of cognitive input devices that could potentially be implemented.

Also depicted here are a plurality of non-cognitive interfaces 216. These would include any input device that involves some sort of physical movement by the user rather than merely thoughts. While traditional computer input (e.g., keyboard, mouse, touchscreen) would certainly qualify as a non-cognitive interface, these are not depicted here because it may be assumed that these traditional computer input techniques may not be available or desirable to use to the user, at least at this particular time, at least partially, thus necessitating a different type of input. Examples of non-cognitive interfaces 216 include vision 218 (e.g., eyeball tracking), audio 220 (e.g., sounds), video 222 (e.g., physical movements and sounds), location 224 (e.g., movement to a different place), and gestures 226.

In an example embodiment, a deep learning orchestration base 228 provides multiple machine learning models based on deep learning. A deep learning model refers to a computational framework designed to analyze and interpret complex data through multiple layers of interconnected processing units, called neurons, which are inspired by the structure of the human brain. Deep learning models utilize a network of algorithms that work together to recognize patterns in data and make predictions or classifications based on that data.

At the core of deep learning models is the neural network structure. This structure is composed of layers of neurons, each performing a series of mathematical functions. The depth of the network is determined by the number of layers between the input and the output. The input layer receives data, and subsequent hidden layers transform and process this data through weighted connections, with each layer learning different aspects of the input information. The output layer produces the final result or decision, which can be a prediction, classification, or another form of output depending on the task.

Each neuron within the network performs a mathematical operation on the inputs it receives. The result is passed through an activation function, which introduces non-linearity into the model, enabling it to capture and represent complex patterns in the data. These activations allow the model to adapt to and learn from data that is not strictly linear in nature.

The training process of a deep learning model involves adjusting the weights of connections between neurons through a method known as backpropagation. This process uses an optimization technique, such as gradient descent, to iteratively minimize the error between the model's predictions and the actual outcomes. Over time, this optimization leads to a model capable of making highly accurate predictions or classifications on new, unseen data.

Deep learning models can be employed in a wide range of tasks depending on the specific architecture of the model. For example, Convolutional Neural Networks (CNNs) are specialized for analyzing visual data, such as images or video, by identifying spatial hierarchies and patterns in pixel data. Recurrent Neural Networks (RNNs), on the other hand, are designed to process sequential data, such as time series or natural language, by maintaining internal states that capture information about previous inputs. Other architectures like Generative Adversarial Networks (GANs) are used to generate synthetic data that mimics a given dataset, which has applications in image generation and enhancement. Additionally, transformer-based architectures are widely applied in natural language processing tasks, enabling models to understand and generate human language effectively.

Here, the deep learning framework may be spread out in various places in the system 200. Specifically, the deep learning orchestration base 228 may control a number of different machine learning axes, specifically first machine learning axis 230, second machine learning axis 232, third machine learning axis 238, fourth machine learning axis 240, fifth machine learning axis 242, sixth machine learning axis 244, and seventh machine learning axis 246. Each axis can be considered to be a machine learning submodel or submodels of the deep learning orchestration base 228 designed to perform a different task.

The first machine learning axis 230 is trained to find correlations between one or more cognitive input devices 202 and one or more non-cognitive interfaces 216. This may be performed on a per-user basis. For example, a specific user may make a gesture (such as a head nod) along with having a particular EEG pattern when attempting to select an item in an area of a graphical user interface. Another user, however, may use a different EEG pattern when attempting to perform the same action. The first machine learning axis 230 is able to determine the correlative patterns and devices for the individual users.

During a training or preprocessing phase, a user may have various thoughts that cause various types of spikes in one or more cognitive input devices 202. For example, the user may have a certain EEG pattern when thinking “create” and a different EEG pattern when thinking “delete”. The first machine learning axis 230 is trained during this process to determine these correlations, and also to correlate those same spikes to input from one or more non-cognitive interfaces 216.

The second machine learning axis 232 then takes the enriched data from the first machine learning axis 230 and further refines and/or filters it into only the data needed to determine the user's intent, formatting the data in a format usable by the rest of the system 200.

The second machine learning axis 232 works closely with a polysift layer 236. The polysift layer 236 will be described in more detail below.

The third machine learning axis 238 further processes or tunes the raw data coming from devices and interaction logs. The fourth machine learning axis 240 fine tunes the frequency and modality for respective individual time series, segmenting them into minute fragments along with the combinations of arrays of data that the user or pretrained model is attempting to achieve. The fifth machine learning axis 242 empowers the ability to retrieve the aggregation of modality and aggregated insights, carefully investigating and backtracking necessary data mismatches. The sixth machine learning axis 244 validates the efficacy of the information, including, but not limited to, the user activity, time series, modality, and insights, and verifies blending of the data points and flows according to the input data. The seventh machine learning axis 246 is responsible for collecting all of the data workings into the enterprise dialer, interfacing in real time with a simulation module and the deep learning orchestration base 228.

The polysift layer 236 performs the preliminary understanding of the meaning of cognitive input from the various cognitive input devices 202 as well as input from the non-cognitive interfaces. It acts to perform a sort of “pre-understanding” of the user's intent by first attempting to derive the meaning of individual input to individual input devices via the primary sift layer 248. The primary sift layer 248 generates understandings of user intent for individual pieces of input. A figment proxy model 250 then uses these individual understandings and generates an understanding of overall intent across the multiple inputs. The data is input in time series form but is in fragments. These fragments may be stored in a continuous fragment repository 252. The primary sift layer 248 and the figment proxy model 250 can retrieve these fragments and analyze the fragments. The figment proxy model 250 then pieces the fragments all together to generate an overall understanding of user intent.

A datasift layer 254 acts to further refine the data and learn intent of the user generally. A post-datasift layer 256 then connects the dots between all the patterns and all the connections. An enterprise operations dialer 258 then connects the intent of the user to one or more organization processes, determines workflows from these organization processes, and presents the workflows in a unique user interface. The pre-datasift layer 253, datasift layer 254, post-datasift layer 256, and enterprise operation dialer 258 will be described in more detail below.

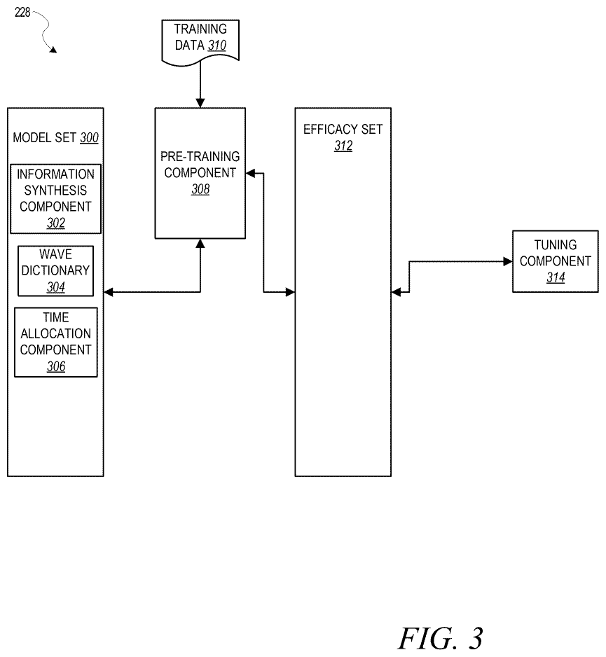

FIG. 3 is a block diagram illustrating the deep learning orchestration base 228 of FIG. 2 in more detail. Here, the deep learning orchestration base 228 includes a model set 300. The model set 300 includes a linguistic base, which includes semantics and grammars of multiple languages. Here, since the input is cognitive, it is not limited to a single language and thus the system is able to support many different languages. Each of the supported languages will have semantics and grammars stored in the model set 300. An information synthesis component 302 contains information about the specific type of information the user is interacting with. This information could be, for example, information about the functioning of a particular organization or industry, or even a specific type of interactive system, such as a customer relationship management (CRM) system or enterprise resource planning (ERP) system.

A wave dictionary 304 contains data about time series waves, including a summary of frequencies and intervals and their corresponding meanings. Each time series comprises a wave of input over time. Each type of input device may have its own typical waves corresponding to particular typical thoughts or intents. The wave dictionary 304 stores this information.

A time allocation component 306 tracks intervals of times of the waves stored in the wave dictionary 304. This could be milliseconds, microseconds, etc. These time intervals can be customized based on user and system preferences.

A pre-training component 308 then acts to pre-train the deep learning orchestration base 228 using training data 310 as well as the information from the model set 300. The pre-training component 308 may include one or more large language models (LLMs).

LLMs used to generate information are generally referred to as Generative Artificial Intelligence (Gen AI) models. A Gen AI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs comprise a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This contrasts with prior art solutions that looked at a text sequence either from left to right or combined left to right and right to left. A bidirectionally trained language model has a deeper sense of language context and flow than single-direction language models.

More specifically, the transformer encoder reads the entire sequence of information, and thus is considered to be bidirectional (or, alternatively, non-directional). This characteristic allows the model to learn the context of a piece of information based on all its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory) until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, though a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

An efficacy set 312 then includes information about errors and conformance. Errors are issues that occurred with the system when operating. Conformance means how well these errors have been corrected. This is a recursive process, where an error occurs, the error is attempted to be remedied, and conformance is measured to see how well the error has been remedied, and this keeps repeating until the error is determined to have been remedied. This is not just performed a single time; the process keeps working on every interval of time to ensure that the system is obtaining all needed information and conforming to user and system requirements.

A tuning component 314 may then perform tuning of the deep learning orchestration base 228. This tuning can be performed at an organization level or at a user level. For example, at an individual user level, a calibration phase may occur where the user is asked to think of certain specific things, and then the corresponding cognitive input data for the user is measured. The user can also be asked to not think of anything for certain periods of time to allow for tracking of cognitive input data when the user is not actively thinking of anything. This tuning information can then be used to fine-tune the deep learning orchestration base 228 for use with that user. Similar fine tuning can occur with other users in the organization to fine tune the deep learning orchestration base 228 for all users within the organization.

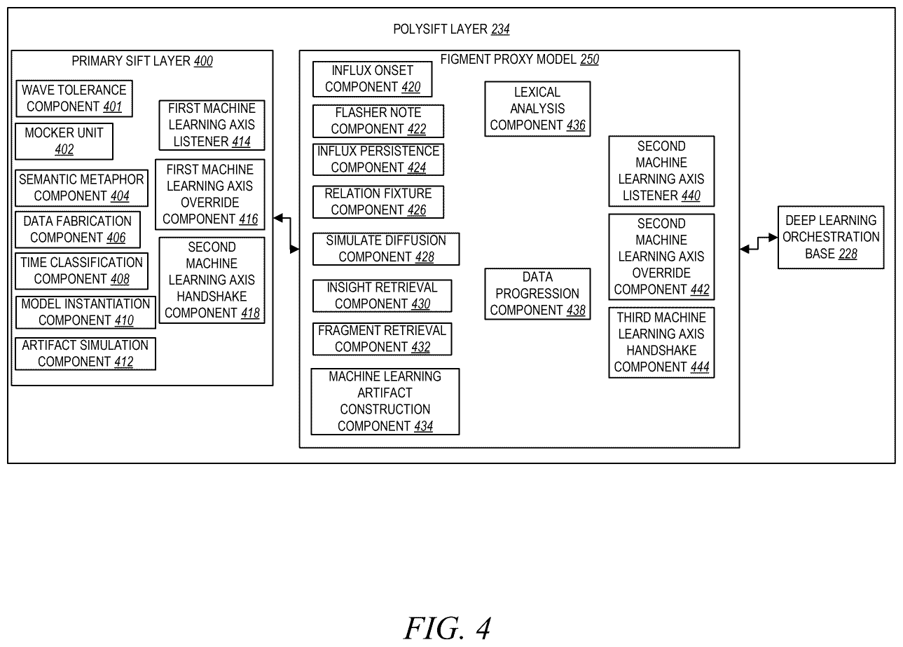

FIG. 4 is a block diagram illustrating the polysift layer 234 of FIG. 2 in more detail. The polysift layer 234 includes a primary sift layer 400 that has a wave tolerance component 401. The wave tolerance component 401 handles scenarios where there are multiple different input waves being received at or near the same time. The wave tolerance component 401 acts to ensure that the input data is appropriately separated into distinct and separate waves. As part of this process, a mocker unit 402 supports the wave tolerance component 401 by checking the waves periodically (e.g., every second, millisecond, etc.) to understand if there is any deviation in the waves indicating a distinct waveform.

As mentioned earlier, the techniques described herein allow the system to perform cognitive input recognition in real-world environments. This may include environments that are noisy, either via audio (e.g., a loud environment) or via other interference, such as electromagnetic force (EMF) from surrounding devices or infrastructure. For example, a user may be carrying a mobile device that emits EMFs that may create noise on a particular waveform, such as a waveform coming from an EEG. Thus, the wave tolerance component 401 and mocker unit 402 are able to aid in distinguishing legitimate waves from noise.

A semantic metaphor component 404 takes the analytics from the wave tolerance component 401 and the mocker unit 402 and articulates preliminary conclusions about the waveforms. A data fabrication component 406 provides further understanding, along with a time classification component 408, of how many different devices the user is connected to that provide cognitive input and what those devices are. This is helpful in scenarios where the system is capable of many different types of cognitive interfaces but the user is only utilizing a small subset of those possible cognitive interfaces. This helps to cover scenarios where the user is unable or unwilling to provide explicit instruction about which cognitive interfaces are being used. The data fabrication component 406 is still able to come to conclusions about which interfaces are being used even without this direct instruction from the user.

A model instantiation component 410 acts to instantiate a figment proxy model 250 to ensure that the figment proxy model 250 understands data across all the different cognitive input modalities. An artifact simulation component 412 simulates waveforms that are expected to come in as input data. These simulated waveforms may be used by, for example, the conformance aspects of the efficacy set 312 in FIG. 3. The artifact simulation component 412 ensures that the input data conforms to the semantics the system has learned and the guidelines for the model (and possibly user-specific guidelines) as to what is hoped to be achieved.

A first machine learning axis listener 414 attempts to understand the interactions between the first machine learning axis 230 and other components. It listens in on these interactions and performs various learning tasks to generate that understanding. Based on the understanding of the interactions between the first machine learning axis 230 and the other components, a first machine learning axis override component 416 can override one or more of these interactions. This may include, for example, if the interactions violate the earlier-described semantics and guidelines.

A second machine learning axis handshake component 418 then handshakes with the second machine learning axis 232 to provide information to and receive information from the second machine learning axis 232.

The figment proxy model 250 acts to put together all the various pieces of information from various cognitive interfaces and waveforms from those interfaces and derive a consistent interpretation of user intent based on all this information. It can analyze and compile the fragments. It can also perform lexical analysis. This may include interacting with the second machine learning axis 232 to rectify any gaps in the data as well as to validate the information.

An influx offset component 420 receives the influx of data, which has been sifted by the polysift layer 234. A flasher note component 422 then keeps track of these influxes and creates an alert if something goes wrong. This can occur if, for example, the artifact simulation component 412 generates a simulated artifact that does not match the contours of a specific piece of data, such as if the data or time classifications are not within a predefined threshold of the simulated artifact. The alert causes the primary sift layer 400 to reevaluate that fragment and understand what went wrong in either the data fabrication or time classification, and then repeat the simulation. This is a repetitive process in which two-way communication is performed until the flasher note component 422 is satisfied with the similarity between the simulated sampling and the actual influx.

An influx persistence component 424 persists the influx once it is determined that the influx is good.

A relation fixture component 426 makes sure that there are relations between influxes that are related to each other. This allows for further fine tuning during instantiation of the model simulation. A simulate diffusion component 428 simulates again, this time differentiating individual pieces and understanding if the differentiation between them means that everything is working. This involves looking at the divisions among the fragments and then combining the fragments to make sure that everything still makes sense both ways.

Once the simulation of these individual pieces if performed, an insight retrieval component 430 retrieves an insight and a fragment retrieval component 432, and these are passed along to a machine learning artifact construction component 434. The machine learning artifact construction component 434 constructs an artifact using the individual fragments and any insights.

A lexical analysis component 436 then performs lexical analysis on the artifacts. Lexical analysis is a process that breaks down input into small parts, called tokens or lexemes, which helps computers understand the input for further analysis.

Once input has been tokenized into meaningful units, the next step in the machine learning pipeline is converting these tokens into numerical features that algorithms can process. This transformation is useful because machine learning models require numerical input to perform tasks like classification, sentiment analysis, or translation.

One approach to converting tokens into numerical features is called Bag of Words (BoW). In this method, the text is represented as a vector of word frequencies. The key idea is that the presence or absence of words in a document matters, but their order does not. A vocabulary is created from the entire corpus, listing all the unique words, and each document is then converted into a vector where each element corresponds to a word in that vocabulary. The value for each word in the vector is the count of that word in the document. While BoW is simple and effective, it doesn't capture word order and can lead to high-dimensional, sparse vectors, especially with large corpora.

To address some of BoW's shortcomings, TF-IDF (Term Frequency-Inverse Document Frequency) is often used. TF-IDF refines the basic frequency count by considering how common or rare a word is across the entire corpus. Term Frequency (TF) measures how often a word appears in a document, while Inverse Document Frequency (IDF) adjusts this measure by downplaying words that appear frequently across many documents, as they are less informative. By multiplying these two components, TF-IDF highlights words that are both frequent in a document and rare across the corpus, making them more meaningful for distinguishing between documents.

Another possible method involves word embeddings, which represent words as continuous vectors in a high-dimensional space. Unlike the discrete, high-dimensional vectors in BoW or TF-IDF, word embeddings capture semantic relationships between words. Words that are similar in meaning, like “king” and “queen,” will have similar vector representations. Possible algorithms for generating word embeddings include Word2Vec and GloVe, both of which learn these vectors by processing large text corpora. Word2Vec, for instance, learns by predicting words based on their surrounding context, while GloVe focuses on factorizing the co-occurrence matrix of words across the corpus. This approach enables the model to capture subtle nuances of meaning and context, which makes word embeddings particularly useful for tasks like sentiment analysis and machine translation.

It should be noted that while here BoW is described with respect to words, in the present disclosure the tokens being used may not be words but may be more general expressions of user intent.

An extension of word embeddings is FastText, which improves on traditional word embeddings by considering subword information. While traditional models treat words as indivisible units, FastText breaks words into smaller components, like n-grams. This allows it to handle out-of-vocabulary words more effectively by leveraging the internal structure of words, making it especially useful for languages with a lot of word variation or for applications dealing with new, rare words.

Other models, such as transformed-based models like Bidirectional Encoder Representations from Transformers (BERT) use attention mechanisms to dynamically adjust the importance of different words in a sentence based on their context, considering both the words that come before and after a target word. Unlike methods like Word2Vec, where words have fixed embeddings, transformers generate contextual embeddings, meaning the representation of a word can change depending on its surrounding words. This ability to understand context in a deeper way has led to significant advances in tasks like question answering, text classification, and machine translation.

Ultimately, these techniques—whether through simple frequency counts, refined representations like TF-IDF, or the complex, context-aware embeddings of transformer models—are all designed to turn raw text into numerical features that machine learning models can process. The choice of technique depends on the specific task and the nature of the text, with newer methods like transformers offering increasingly sophisticated ways to understand and represent language.

Once this lexical analysis is complete, a data progression component 438 acts as sort of a toll gate to ensure that all the prior processing is adhering to the principles established for the model and the user. The user has privileges to alter any of the changes that the model wishes to achieve. Only once the guidelines have been met for the model and the user is the system able to continue to process the input data.

A second machine learning axis listener 440 attempts to understand the interactions between the second machine learning axis 232 and other components. It listens in on these interactions and performs various learning tasks to generate that understanding. Based on the understanding of the interactions between the second machine learning axis 232 and the other components, a second machine learning axis override component 442 can override one or more of these interactions. This may include, for example, if the interactions violate the earlier-described semantics and guidelines.

A third machine learning axis handshake component 444 then handshakes with the third machine learning axis 238 to provide information to and receive information from the third machine learning axis 238.

For purposes of this disclosure, a figment is an ordered portion of a more complete data fragment.

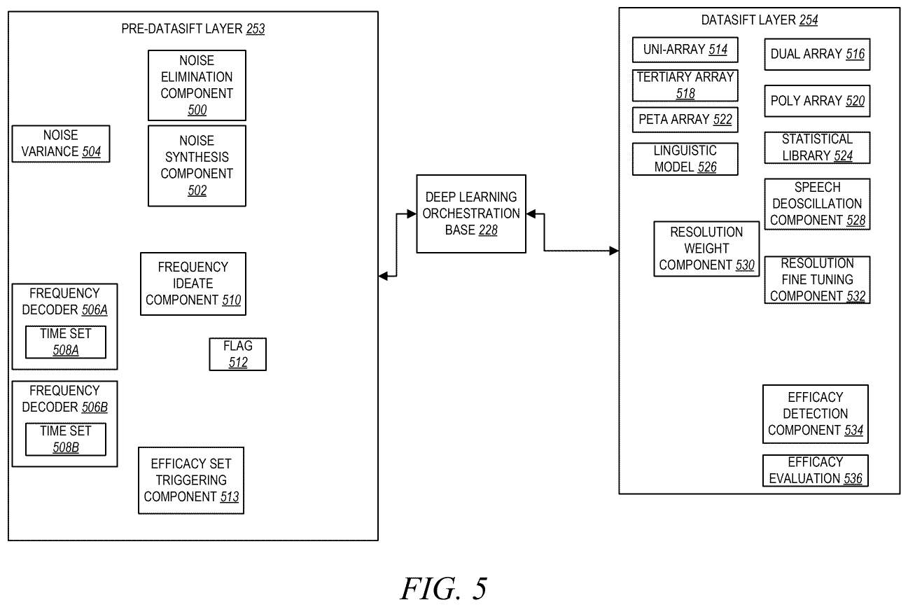

FIG. 5 is a block diagram illustrating the pre-datasift layer 253 and datasift layer 254 of FIG. 2 in more detail. The pre-datasift layer 253 helps to ensure that the data that is coming from the sensors and input devices is consistent. This is especially useful in “noisy” environments, meaning environments in which false data (noise) is included within the actual data. This may be from other devices interfering with the input devices used by the user (e.g., a microphone picking up external noise from a room, or EMF from a mobile device adding electronic noise to an EEG signal, etc.), or it can simply be input being received from an input device the user isn't using at the moment, such as a user sleeping causing an unusual EEG reading. The pre-datasift layer 253 helps to differentiate between the gestures, eye blinks, etc., and noise. The pre-datasift layer 253 also contains components to generate noise to teach the system to differentiate between actual data and noise. Specifically, a noise elimination component 500 acts to filter out or otherwise eliminate noise introduced into the system. A noise synthesis component 502 acts to generate additional noise that can be used to train the system. A noise variance component 504 takes input data and divides it into actual data and noise elements.

The actual data can then be decoded into different frequencies, using multiple frequency decoders 506A, 506B, which produce multiple time sets 508A, 508B, respectively. While two frequency decoders 506A, 506B are depicted here, it should be noted that in actuality there may be any number of frequency decoders in the system, one for each frequency to be decoded.

A frequency ideate component 510 then determines meaning for the frequencies coming in. If any issues occur, then the frequency ideate component 510 is able to raise a flag 512. The flag 512 alerts a user so that they can change the system to address whatever issue arose.

An efficacy set triggering component 513 uses all the gathered information and triggers an efficiency set 312 (shown in FIG. 3). As mentioned previously, the efficacy set 312 performs the error conformance to make sure that everything is applied according to user requirements. Once that is done, the information can be passed to the deep learning orchestration base 228.

As to the datasift layer 254, a series of arrays are used to try the different combinations of fragments to determine whether certain combinations match the user's intent. This series of arrays include a uni-array 514, a dual array 516, a tertiary array 518, a poly array 520, and a peta array 522. Each of these arrays can hold a different number of fragments. For example, the uni-array 514 holds a single fragment, the dual array 516 holds two fragments, the tertiary array 518 holds three fragments, and so on. A statistical library 524 contains statistical algorithms used to analyze these different combinations of fragments.

A linguistic model 526 is then used to define the specifics of the language or languages supported.

A speech deoscillation component 528 works with the resolution weight component 530 and the resolution fine tuning component 532 to understand the context and what is happening in the system to fine tune the system and detect and evaluate the fragments. Deoscillation can work in two different ways. First, irrelevant waveforms may be removed, such as by removing background noise of someone speaking. Second, relevant related waveforms may be highlighted, such as if one user wants to create a sales order and, in the background, another user says “No, let's create a purchase order instead.” The system can use this as feedback, even though it is not from the user operating the cognitive interface.

An efficacy detection component 534 is then able to detect the efficacy of the model, and the efficacy evaluation component 536 makes sure that the data is close to an expected efficacy.

As an example, assume the user wishes to select a sales order. The input the user is desiring is “sales order,” the operation dialer switches automatically once the system determines that is what the user is thinking of figments is associated with a different array. The statistical library 524 is connected to the different models to ensure that all the models receive the conclusions about the information in the arrays based on the statistical library 524.

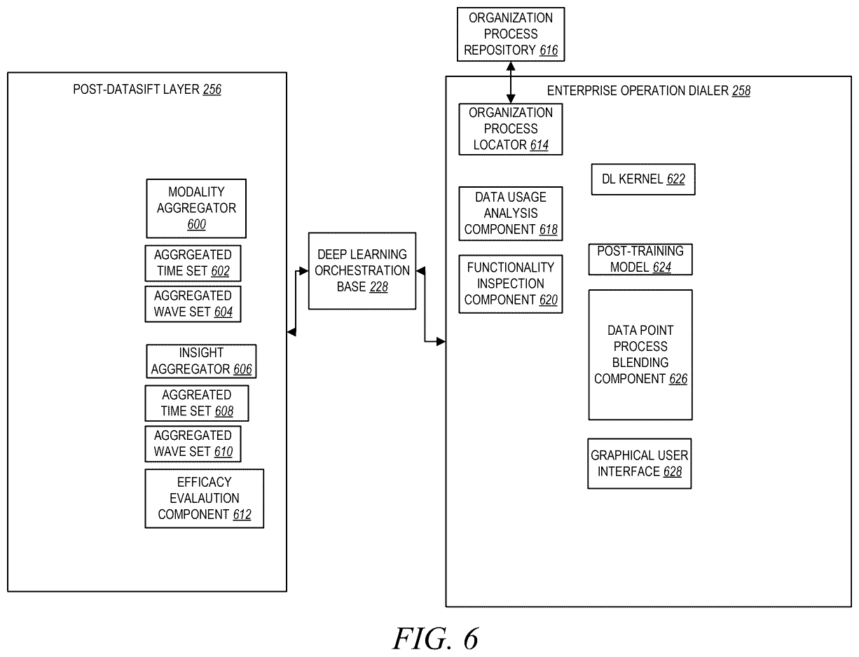

FIG. 6 is a block diagram illustrating the post-datasift layer 256 and the enterprise operation dialer 258 of FIG. 2 in more detail, in accordance with an example embodiment. Turning first to the post-datasift layer 256, this layer attempts to come to conclusions about how the input data makes some sense.

Data from all the previous models, including modality and insight information, are input into the post-datasift layer 256. A modality aggregator 600 acts to aggregate all the modalities. More specifically, each time set of each modality is aggregated into an aggregated time set 602, while each wave of each modality is aggregated into an aggregated wave set 604.

Likewise, all the insights are aggregated by an insight aggregator 606. Like with the modality aggregator 600, this creates aggregated time set 608 and aggregated wave set 610. Like with previous steps, an efficacy evaluation component 612 determines whether the system is still behaving as desired and if there are any issues or errors. Once that is done, all of this information is passed to the deep learning orchestration base 228, which ensures that all the information is accurate and all the models are working as intended. The information can then be passed to the enterprise operation dialer 258.

The purpose of the enterprise operation dialer 258 is to identify organizational processes related to the intent of the user, determine workflows of those processes, and present a user interface that allows the user to select particular steps of the workflows using the cognitive interfaces. In other words, it allows the system to automatically determine which workflow the user is attempting to operate in and to present specific steps of that workflow for selection, depending upon where in the workflow the system is currently operating. For example, a user may wish to create a specific sales order. In that case, it may not make sense to provide the user with an option to create a purchase order if the user (and other users in the organization) do not create a purchase order from the point in the workflow the user is currently operating.

An organization process locator 614 identifies, based on contextual information and potentially prior user input, relevant organization processes. This may include accessing an organization process repository 616. The organization processes may include workflows, which essentially are sequences of steps, with each step causing another one or more steps to be allowed to be performed once the step has completed.

At its core, an organization process helps an organization deliver value consistently and efficiently.

The process is organized into workflows, which are essentially the path that each task or step follows. This represents the flow of work from one system or component to another. These workflows are designed to make sure each step is completed in the right order, ensuring nothing is overlooked. Each step usually has a clear purpose, whether it's gathering information, making decisions, or taking actions.

A data usage analysis component 618 analyzes past usage history of the relevant workflows to identify common patters. A functionality inspection component 620 analyzes the functionality of each step to identify meanings of the steps. A deep learning kernel 622 then takes the information from the data usage analysis component 618 and the functionality inspection component 620 and uses it to perform deep learning to train a post-training model 624.

A data point process blending component 626 then blends steps and entities of the process to points in a graphical user interface 628. As will be described below, each likely step that the system believes the user may select from a given place in a workflow may be presented as a different point within a dialer, which is a geometric shape with delineated points. A user is then able to use the cognitive interface(s) to select one or more points to identify corresponding steps and/or entities to be selected.

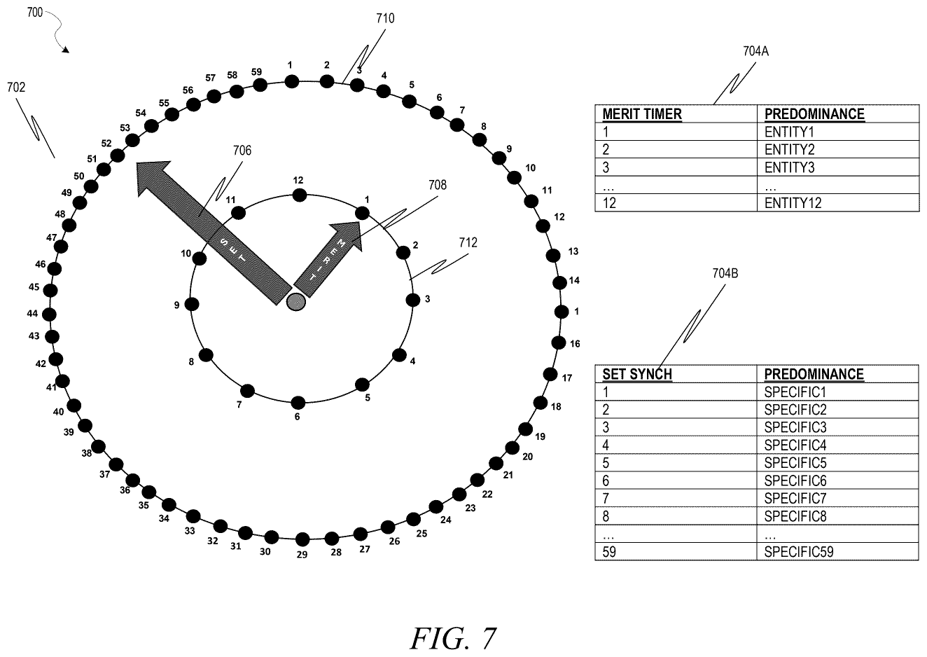

FIG. 7 is a diagram illustrating an example graphical user interface 700, in accordance with an example embodiment. The graphical user interface 700 includes a dialer 702 and one or more charts 704A, 704B. The concept behind the dialer 702 is to provide the ability for the user to use one or more cognitive interface(s) to rotate a set of arrows, here depicted as a set arrow 706 and a merit arrow 708. Each arrow can be made to point to a specific point in a geometric shape. Here, both the set arrow 706 and the merit arrow 708 point to different points on two different circles, specifically circle 710 and circle 712, respectively.

It should be noted that there is no requirement that the shapes be circles. Any geometric shapes in which points can be depicted and delineated can be used. Furthermore, there is no requirement that the shapes in a single graphical user interface 700 both be the same. Here, for example, a circle within a circle is depicted, but many other possibilities are available as well, such as a circle within a square, a square within a circle, a triangle within a rectangle, a rectangle within a rectangle, etc.

Here a circle within a circle has been chosen for several reasons. First of all, a circle is a shape that provides the most number of possible points that can be easily delineated using an arrow. Thus here, as can be seen, the outer circle 710 contains fifty-nine distinct points, allowing for fifty-nine distinct selections. Another shape, such as a triangle, would not allow for as many distinct selections. Second of all, the circle within a circle resembles an analog clock, which most users are familiar with. This not only improves the user experience by presenting the user with a user interface that the user has general familiarity with, but it also makes it more likely that the cognitive input will be interpreted correctly.

It should also be noted that there is no requirement that there be exactly two shapes (one within the other). Embodiments are foreseen where there are more than two shapes. For example, there could be three concentric circles and three corresponding arrows to select points on those three concentric circles.

Each point may correspond to a different entity and/or step in an organization process. In an example embodiment, one of the shapes may correspond to entities and the other of the shapes may correspond to steps.

The charts 704A, 704B act as a “legend”, informing the viewer of what each point in each shape represents. Thus here, as can be seen, the outer circle 710 corresponds to steps, with each step indicated in chart 704B using a specific name. Likewise, the inner circle 712 corresponds to entities, with each entity indicated in chart 704A using a specific name. For purposes of this disclosure, an entity is a data structure or component within the system, or a representation of some other object. This is distinguishable from a step, which is an operation or action within a workflow.

Steps and entities go hand in hand. A step may act upon or otherwise involve one or more entities, and thus it is beneficial to provide a single user interface where selection of both step and entity are possible within a single view.

Thus, the user is able to use the aforementioned cognitive interfaces to rotate the merit arrow 708 to a particular point on the inner circle 712 to select a particular entity, while also using the aforementioned cognitive interfaces to rotate the set arrow 706 to a particular point on the outer circle 710 to select a particular step.

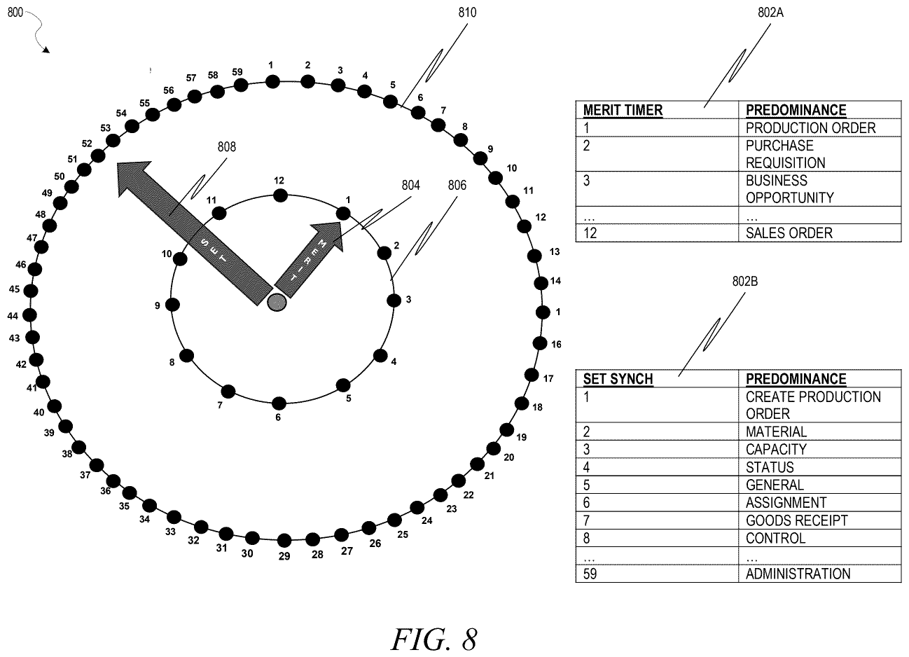

FIG. 8 is a diagram illustrating an example graphical user interface 800 having specific values for entities and steps, in accordance with an example embodiment. Here, chart 802A indicates various specific entities that can be selected by controlling the merit arrow 804 to particular points on the inner circle 806. Likewise, chart 802B indicates various specific steps that can be selected by controlling the set arrow 808 to particular points on the outer circle 810.

It should also be noted that the specific graphical presentations illustrated in FIGS. 7 and 8 are not required. In some circumstances, for example, it may be beneficial to explicitly list the entities and the steps next to the points themselves, as opposed to what is depicted in FIGS. 7 and 8 where a number is depicted next to the points and separate charts are provided for the user to identify which numbers correspond to which entities/steps.

Additionally, in some example embodiments it may be beneficial to highlight or make some other visual indication of recommended selections. These recommendations may be based on, for example, prior usage history by other users, either overall or within the user's organization, as well as based on prior usage history of the user. These recommendations may be presented in a variety of ways. In some instances, a recommended entity and/or step may have their corresponding points highlighted, such as by using a different color than other points. In other example embodiments, multiple different colors can be used to indicate different levels of recommendation. For example, steps that the system thinks there is a high likelihood the user will wish to select may be highlighted in green, steps the system thinks there is a medium likelihood the user will wish to select may be highlighted in amber, and steps the system thinks there is a low likelihood the user will wish to select may be highlighted in red.

The ordering of the entities and/or steps as reflected in corresponding points in the shapes and in the charts can also be based on some level of recommendation. For example, in FIG. 8, it may be that “create production order” is chosen as having the top spot in chart 802B because it is the step the system thinks the user is likeliest to select, whereas “administration” is chosen as having the bottom spot in chart 802B because it is step the system thinks the user is least likely to select. The rest of the ordering of the steps in the chart 802B may likewise be reflective of relative likelihood of selection.

In addition to, or in lieu of, likelihood of selection, other factors may play a role in the ordering and/or highlighting of certain entities and/or steps in the charts and/or on the shapes themselves. The organization itself may have certain needs or preferences that can be reflected in the ordering. For example, if the organization to which the user belongs has a guideline that production orders should be created before a goods receipt is reflected, then this may play a role in the “create production order” step being placed higher in the corresponding chart than the “goods receipt” step.

Additionally, in an example embodiment, because the operations dialer is shaped like a clock, the user could think of a time and the system would be able to interpret this time to determine the orientations of the merit and set arrows. For example, if the user thought of the time “3:40”, then the merit arrow 708 could be moved to the “3” and the set arrow 706 could be moved to the “40”, and then the corresponding organizational processes could trigger and be executed in the background.

One technological advantage of utilizing a graphical user interface 800 such as the one depicted here, or another graphical user interface using the “dialer” approach with arrows and geometrical points, is that such a graphical user interface may result in a cognitive interface that is easier for the user to accurately use. Specifically, while it is possible to train the system models to allow for the user to indicate a particular direction along the three hundred and sixty degree circle using only their mind, this level of precision may prove difficult to detect. For example, the system would need to be able to distinguish between the user thinking about the arrow pointing to point nine rather than pointing to point ten. The dialer interface allows for a different type of training and measurement, more specifically the use of clockwise and counterclockwise movements to move the arrows one by one around the points. Thus, for example if the arrow is currently pointing to point two and the user wishes to select a step associated with point fifteen, rather than the user needing to think “make the arrow point directly to the right” or “make the arrow point specifically at point 15”, the user need only think “make the arrow rotate to the right” and then when the arrow gets to point fifteen the user need only think “make the arrow stop there”. As such, the system only needs to be trained with a smaller number of cognitive selections, such as “move the merit arrow clockwise”, “stop the merit arrow”, move the merit arrow counterclockwise”, “move the set arrow clockwise”, “stop the set arrow”, and “move the set arrow counterclockwise.”

It should be noted that embodiments are also possible where the user does not necessarily need to think of a specific position for the arrows, but instead can think of the overarching goals (e.g., select on create a production order) and the arrows move to the corresponding spots, which the user can merely verify.

Once the selection is made, the system can automatically launch the corresponding action with whatever selected status, essentially prepopulating the action with the selected status. Thus, for example, if the user selects merit timer value of 12 and set synch of 2, then the system may launch a sales order prepopulated with the field ready to accept a material.

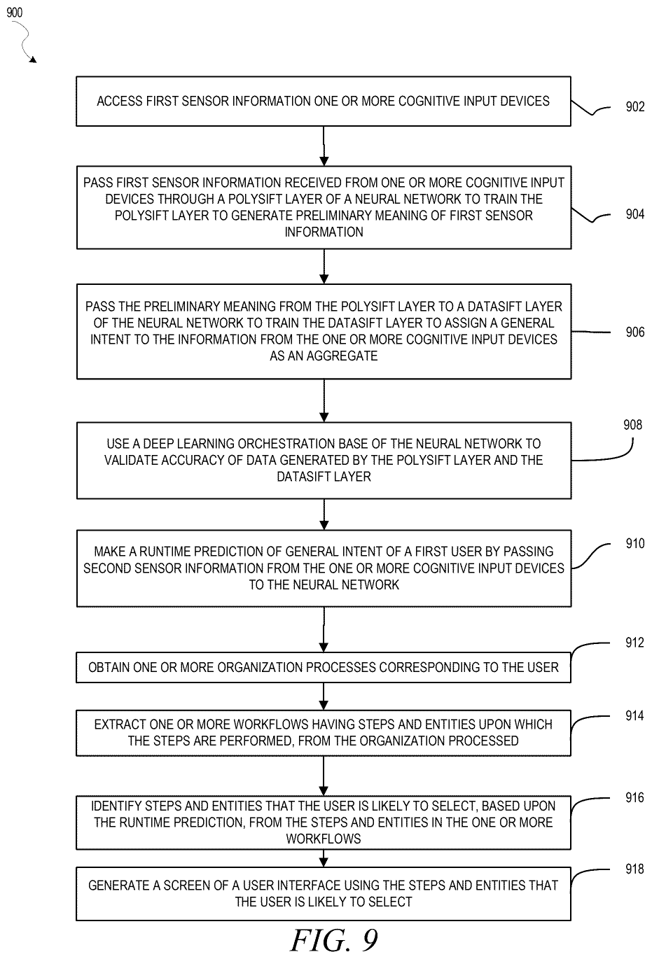

FIG. 9 is a flow diagram illustrating a method 900 for processing signals from one or more cognitive interfaces, in accordance with an example embodiment.

At operation 902, first sensor information is received from one or more cognitive input devices. This first sensor information may take the form of waveforms and time series data. At operation 904, the first sensor information is passed through a polysift layer of a neural network. This trains the polysift layer to assign a preliminary meaning to individual sensor waveforms and/or time series from each of the one or more cognitive input devices. The polysift layer may utilize a figment proxy model to perform lexical analysis of data.

At operation 906, the preliminary meaning is passed from the polysift layer to a datasift layer of the neural network to train the datasift layer to assign a general intent to the information as an aggregate by trying different combinations of fragments of the information and comparing the combinations to a linguistic model.

At operation 908, a deep learning orchestration base of the neural network is used to validate accuracy of data generated by the polysift data and the datasift layer.

At operation 910, a runtime prediction of general intent of a first user is made by passing second sensor information from the one or more cognitive input devices to the neural network.

Operations 912-918 are then performed by an operations dialer. At operation 912, the operations dialer obtains one or more organization processes corresponding to the user. This may include one or more organization processes of an organization to which the user belongs. At operation 914, one or more workflows are extracted from the organization processes. These one or more workflows may have steps and entities upon which the steps are performed.

At operation 916, steps and entities that the user is likely to select are identified, based on the runtime prediction, from the steps and entities in the one or more workflows. At operation 918, a screen of a user interface is generated using the steps and entities that the user is likely to select.

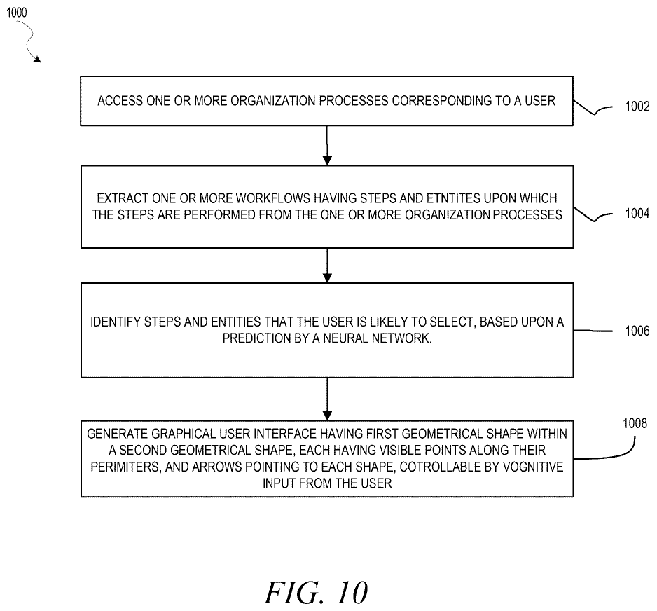

FIG. 10 is a flow diagram illustrating a method 1000 for generating a user interface, in accordance with an example embodiment. At operation 1002, one or more organization processes corresponding to a user are accessed. At operation 1004, one or more workflows having steps and entities upon which the steps are performed are extracted from the one or more organization processes.

At operation 1006, steps and entities that the user is likely to select are identified, from the steps and entities in the one or more workflows, based upon a prediction made by a neural network. At operation 1008, a graphical user interface is generated having a first geometrical shape within a second geometrical shape, each having visible points along their perimeters. Each visible point in the first geometrical shape corresponds to a different entity of the entities that the user is likely to select whereas each visible point in the second geometrical shape corresponds to a different step of the steps the user is likely to select.

The graphical user interface further comprises a first arrow and a second arrow originating from a center of the first geometrical shape, the first arrow ending at one of the visible points in the first geometrical shape, the second arrow ending at one of the visible points in the second geometrical shape, the graphical user interface configured to receive sensor information from one or more cognitive input devices and to rotate either the first arrow or the second arrow so that either the first arrow or second arrow ends at a different one of the visible points than it did before the sensor information was received.

In view of the disclosure above, various examples are set forth below. It should be noted that one or more features of an example, taken in isolation or combination, should be considered within the disclosure of this application.
Example 1 is a system comprising: at least one hardware processor; a neural network comprising a polysift layer having a figment proxy model, a datasift layer, and a deep learning orchestration base; an operations dialer comprising a graphical user interface; a non-transitory computer-readable medium storing instructions that, when executed by the at least one hardware processor, cause the at least one hardware processor to perform operations comprising: passing first sensor information received from one or more cognitive input devices through the polysift layer to assign a preliminary meaning to individual sensor waveforms from each of the one or more cognitive input devices; passing the preliminary meaning to the datasift layer to determine intent by analyzing information fragment combinations against a linguistic model; validating accuracy of data generated by the polysift layer and the datasift layer using the deep learning orchestration base; and causing an operations dialer to: obtain one or more organization processes corresponding to a first user; extract one or more workflows having steps and entities upon which the steps are performed, from the organization processes; identify likely user selections based upon the intent; and generate a screen of the user interface with likely user selections.
In Example 2, the subject matter of Example 1 includes, wherein the deep learning orchestration base comprises a large language model (LLM).
In Example 3, the subject matter of Examples 1-2 includes, wherein the steps and entities that the first user is likely to select are identified based on usage history of a plurality of users.
In Example 4, the subject matter of Examples 1-3 includes, wherein the steps and entities that the first user is likely to select are identified based on usage history of the first user.
In Example 5, the subject matter of Examples 1-4 includes, wherein the neural network further comprises a pre-datasift layer designed to filter out noise from waveforms from the one or more cognitive input devices.
In Example 6, the subject matter of Examples 1-5 includes, wherein the one or more cognitive input devices comprise an Electroencephalogram.
In Example 7, the subject matter of Examples 1-6 includes, wherein the one or more cognitive input devices comprise sensor readings generated by user thought.
Example 8 is a method comprising: passing first sensor information received from one or more cognitive input devices through a polysift layer of a neural network to assign a preliminary meaning to individual sensor waveforms from each of the one or more cognitive input devices; passing the preliminary meaning to a datasift layer of the neural network to determine intent by analyzing information fragment combinations against a linguistic model; validating accuracy of data generated by the polysift layer and the datasift layer using a deep learning orchestration base of the neural network; and causing an operations dialer to: obtain one or more organization processes corresponding to a first user; extract one or more workflows having steps and entities upon which the steps are performed, from the organization processes; identify likely user selections based upon the intent; and generate a screen of a user interface with likely user selections.
In Example 9, the subject matter of Example 8 includes, wherein the deep learning orchestration base comprises a large language model (LLM).
In Example 10, the subject matter of Examples 8-9 includes, wherein the steps and entities that the first user is likely to select are identified based on usage history of a plurality of users.
In Example 11, the subject matter of Examples 8-10 includes, wherein the steps and entities that the first user is likely to select are identified based on usage history of the first user.
In Example 12, the subject matter of Examples 8-11 includes, wherein the neural network further comprises a pre-datasift layer designed to filter out noise from waveforms from the one or more cognitive input devices.
In Example 13, the subject matter of Examples 8-12 includes, wherein the one or more cognitive input devices comprise an Electroencephalogram.
In Example 14, the subject matter of Examples 8-13 includes, wherein the one or more cognitive input devices comprise sensor readings generated by user thought.
Example 15 is a non-transitory machine-readable medium storing instructions which, when executed by one or more processors, cause the one or more processors to perform operations comprising: passing first sensor information received from one or more cognitive input devices through a polysift layer of a neural network to assign a preliminary meaning to individual sensor waveforms from each of the one or more cognitive input devices; passing the preliminary meaning to a datasift layer of the neural network to determine intent by analyzing information fragment combinations against a linguistic model; validating accuracy of data generated by the polysift layer and the datasift layer using a deep learning orchestration base of the neural network; and causing an operations dialer to: obtain one or more organization processes corresponding to a first user; extract one or more workflows having steps and entities upon which the steps are performed, from the organization processes; identify likely user selections based upon the intent; and generate a screen of a user interface with likely user selections.
In Example 16, the subject matter of Example 15 includes, wherein the deep learning orchestration base comprises a large language model (LLM).
In Example 17, the subject matter of Examples 15-16 includes, wherein the steps and entities that the first user is likely to select are identified based on usage history of a plurality of users.
In Example 18, the subject matter of Examples 15-17 includes, wherein the steps and entities that the first user is likely to select are identified based on usage history of the first user.
In Example 19, the subject matter of Examples 15-18 includes, wherein the neural network further comprises a pre-datasift layer designed to filter out noise from waveforms from the one or more cognitive input devices.
In Example 20, the subject matter of Examples 15-19 includes, wherein the one or more cognitive input devices comprise an Electroencephalogram.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

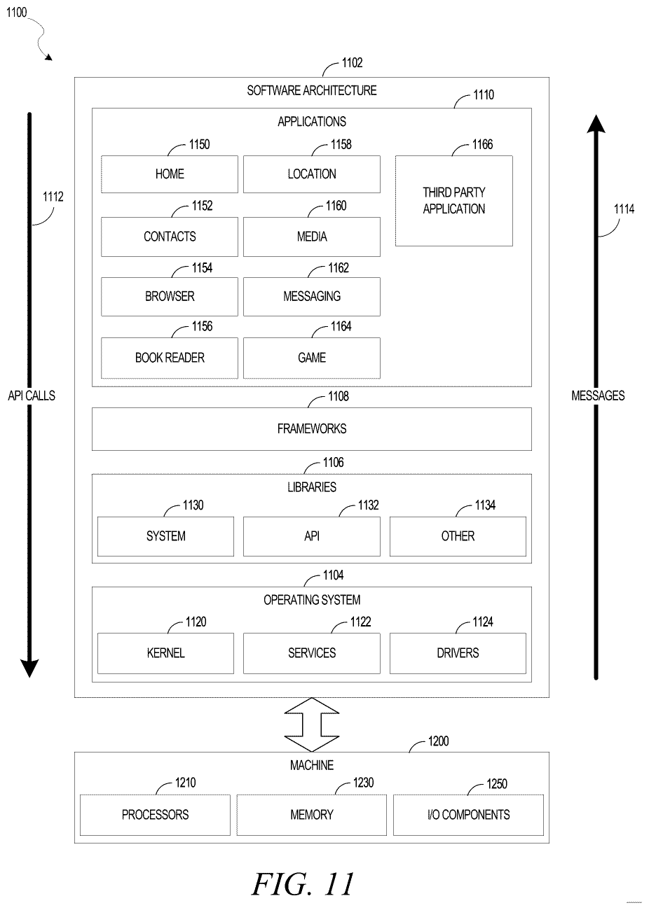

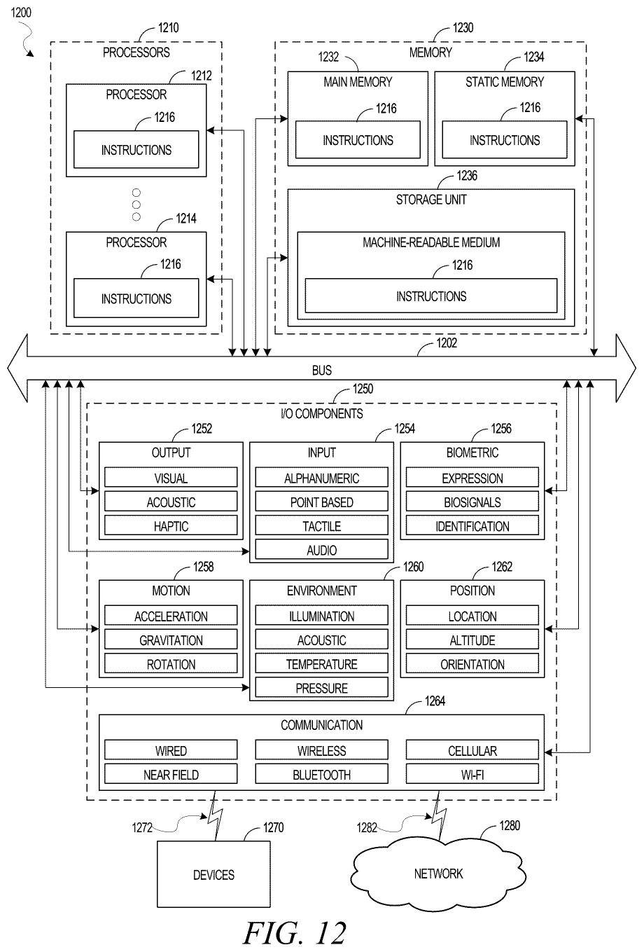

FIG. 11 is a block diagram 1100 illustrating a software architecture 1102, which can be installed on any one or more of the devices described above. FIG. 11 is merely a non-limiting example of a software architecture, and it will be appreciated that many other architectures can be implemented to facilitate the functionality described herein. In various embodiments, the software architecture 1102 is implemented by hardware such as a machine 1200 of FIG. 12 that comprises processors 1210, memory 1230, and input/output (I/O) components 1250. In this example architecture, the software architecture 1102 can be conceptualized as a stack of layers where each layer may provide a particular functionality. For example, the software architecture 1102 comprises layers such as an operating system 1104, libraries 1106, frameworks 1108, and applications 1110. Operationally, the applications 1110 invoke API calls 1112 through the software stack and receive messages 1114 in response to the API calls 1112, consistent with some embodiments.

In various implementations, the operating system 1104 manages hardware resources and provides common services. The operating system 1104 comprises, for example, a kernel 1120, services 1122, and drivers 1124. The kernel 1120 acts as an abstraction layer between the hardware and the other software layers, consistent with some embodiments. For example, the kernel 1120 provides memory management, processor management (e.g., scheduling), component management, networking, and security settings, among other functionalities. The services 1122 can provide other common services for the other software layers. The drivers 1124 are responsible for controlling or interfacing with the underlying hardware, according to some embodiments. For instance, the drivers 1124 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 1106 provide a low-level common infrastructure utilized by the applications 1110. The libraries 1106 can comprise system libraries 1130 (e.g., C standard library) that can provide functions such as memory allocation functions, string manipulation functions, mathematic functions, and the like. In addition, the libraries 1106 can comprise API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 1106 can also comprise a wide variety of other libraries 1134 to provide many other APIs to the applications 1110.

The frameworks 1108 provide a high-level common infrastructure that can be utilized by the applications 1110, according to some embodiments. For example, the frameworks 1108 provide various GUI functions, high-level resource management, high-level location services, and so forth. The frameworks 1108 can provide a broad spectrum of other APIs that can be utilized by the applications 1110, some of which may be specific to a particular operating system 1104 or platform.

In an example embodiment, the applications 1110 comprise a home application 1150, a contacts application 1152, a browser application 1154, a book reader application 1156, a location application 1158, a media application 1160, a messaging application 1162, a game application 1164, and a broad assortment of other applications, such as a third-party application 1166. According to some embodiments, the applications 1110 are programs that execute functions defined in the programs. Various programming languages can be employed to create one or more of the applications 1110, structured in a variety of manners, such as object-oriented programming languages (e.g., Objective-C, Java, or C++) or procedural programming languages (e.g., C or assembly language). In a specific example, the third-party application 1166 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 1166 can invoke the API calls 1112 provided by the operating system 1104 to facilitate functionality described herein.

FIG. 12 illustrates a diagrammatic representation of a machine 1200 in the form of a computer system within which a set of instructions may be executed for causing the machine 1200 to perform any one or more of the methodologies discussed herein, according to an example embodiment. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. For example, the instructions 1216 may cause the machine 1200 to execute the methods 900 and 1000 of FIGS. 9 and 10, respectively. Additionally, or alternatively, the instructions 1216 may implement FIGS. 1-10 and so forth. The instructions 1216 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specifies actions to be taken by the machine 1200. Further, while only a single machine 1200 is illustrated, the term “machine” shall also be taken to comprise a collection of machines 1200 that individually or jointly execute the instructions 1216 to perform any one or more of the methodologies discussed herein.

The machine 1200 may comprise processors 1210, memory 1230, and I/O components 1250, which may be configured to communicate with each other such as via a bus 1202. In an example embodiment, the processors 1210 (e.g., a central processing unit (CPU), a reduced instruction set computing (RISC) processor, a complex instruction set computing (CISC) processor, a graphics processing unit (GPU), a digital signal processor ((SP), an application-specific integrated circuit (ASIC), a radio-frequency integrated circuit (RFIC), another processor, or any suitable combination thereof) may comprise, for example, a processor 1212 and a processor 1214 that may execute the instructions 1216. The term “processor” is intended to comprise multi-core processors that may comprise two or more independent processors (sometimes referred to as “cores”) that may execute instructions 1216 contemporaneously. Although FIG. 12 shows multiple processors 1210, the machine 1200 may comprise a single processor 1212 with a single core, a single processor 1212 with multiple cores (e.g., a multi-core processor 1212), multiple processors 1212, 1214 with a single core, multiple processors 1212, 1214 with multiple cores, or any combination thereof.

The memory 1230 may comprise a main memory 1232, a static memory 1234, and a storage unit 1236, each accessible to the processors 1210 such as via the bus 1202. The main memory 1232, the static memory 1234, and the storage unit 1236 store the instructions 1216 embodying any one or more of the methodologies or functions described herein. The instructions 1216 may also reside, completely or partially, within the main memory 1232, within the static memory 1234, within the storage unit 1236, within at least one of the processors 1210 (e.g., within the processor's cache memory), or any suitable combination thereof, during execution thereof by the machine 1200.

The I/O components 1250 may comprise a wide variety of components to receive input, provide output, produce output, transmit information, exchange information, capture measurements, and so on. The specific I/O components 1250 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 1250 may comprise many other components that are not shown in FIG. 12. The I/O components 1250 are grouped according to functionality merely for simplifying the following discussion, and the grouping is in no way limiting. In various example embodiments, the I/O components 1250 may comprise output components 1252 and input components 1254. The output components 1252 may comprise visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1254 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1250 may comprise biometric components 1256, motion components 1258, environmental components 1260, or position components 1262, among a wide array of other components. For example, the biometric components 1256 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may comprise acceleration sensor components (e.g., accelerometer), gravitation sensor components, rotation sensor components (e.g., gyroscope), and so forth. The environmental components 1260 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1262 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may comprise communication components 1264 operable to couple the machine 1200 to a network 1280 or devices 1270 via a coupling 1282 and a coupling 1272, respectively. For example, the communication components 1264 may comprise a network interface component or another suitable device to interface with the network 1280. In further examples, the communication components 1264 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., coupled via a USB).

Moreover, the communication components 1264 may detect identifiers or comprise components operable to detect identifiers. For example, the communication components 1264 may comprise radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

The various memories (e.g., 1230, 1232, 1234, and/or memory of the processor(s) 1210) and/or the storage unit 1236 may store one or more sets of instructions 1216 and data structures (e.g., software) embodying or utilized by any one or more of the methodologies or functions described herein. These instructions (e.g., the instructions 1216), when executed by the processor(s) 1210, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1280 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1280 or a portion of the network 1280 may comprise a wireless or cellular network, and the coupling 1282 may be a Code Division Multiple Access (CDMA) connection, a Global System for Mobile communications (GSM) connection, or another type of cellular or wireless coupling. In this example, the coupling 1282 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1216 may be transmitted or received over the network 1280 using a transmission medium via a network interface device (e.g., a network interface component comprised in the communication components 1264) and utilizing any one of a number of well-known transfer protocols (e.g., HTTP). Similarly, the instructions 1216 may be transmitted or received using a transmission medium via the coupling 1272 (e.g., a peer-to-peer coupling) to the devices 1270. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 1216 for execution by the machine 1200, and comprise digital or analog communication signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a neural network comprising a polysift layer having a figment proxy model, a datasift layer, and a deep learning orchestration base;
an operations dialer comprising a graphical user interface;
a non-transitory computer-readable medium storing instructions that, when executed by the at least one hardware processor, cause the at least one hardware processor to perform operations comprising:
passing first sensor information received from one or more cognitive input devices through the polysift layer to assign a preliminary meaning to individual sensor waveforms from each of the one or more cognitive input devices;
passing the preliminary meaning to the datasift layer to determine intent by analyzing information fragment combinations against a linguistic model;
validating accuracy of data generated by the polysift layer and the datasift layer using the deep learning orchestration base; and
causing an operations dialer to:
obtain one or more organization processes corresponding to a first user;
extract one or more workflows having steps and entities upon which the steps are performed, from the organization processes;
identify likely user selections based upon the intent; and
generate a screen of the user interface with likely user selections.

2. The system of claim 1, wherein the deep learning orchestration base comprises a large language model (LLM).

3. The system of claim 1, wherein the steps and entities that the first user is likely to select are identified based on usage history of a plurality of users.

4. The system of claim 1, wherein the steps and entities that the first user is likely to select are identified based on usage history of the first user.

5. The system of claim 1, wherein the neural network further comprises a pre-datasift layer designed to filter out noise from waveforms from the one or more cognitive input devices.

6. The system of claim 1, wherein the one or more cognitive input devices comprise an Electroencephalogram.

7. The system of claim 1, wherein the one or more cognitive input devices comprise sensor readings generated by user thought.

8. A method comprising:
passing first sensor information received from one or more cognitive input devices through a polysift layer of a neural network to assign a preliminary meaning to individual sensor waveforms from each of the one or more cognitive input devices;
passing the preliminary meaning to a datasift layer of the neural network to determine intent by analyzing information fragment combinations against a linguistic model;
validating accuracy of data generated by the polysift layer and the datasift layer using a deep learning orchestration base of the neural network; and
causing an operations dialer to:
obtain one or more organization processes corresponding to a first user;
extract one or more workflows having steps and entities upon which the steps are performed, from the organization processes;
identify likely user selections based upon the intent; and
generate a screen of a user interface with likely user selections.

9. The method of claim 8, wherein the deep learning orchestration base comprises a large language model (LLM).

10. The method of claim 8, wherein the steps and entities that the first user is likely to select are identified based on usage history of a plurality of users.

11. The method of claim 8, wherein the steps and entities that the first user is likely to select are identified based on usage history of the first user.

12. The method of claim 8, wherein the neural network further comprises a pre-datasift layer designed to filter out noise from waveforms from the one or more cognitive input devices.

13. The method of claim 8, wherein the one or more cognitive input devices comprise an Electroencephalogram.

14. The method of claim 8, wherein the one or more cognitive input devices comprise sensor readings generated by user thought.

15. A non-transitory machine-readable medium storing instructions which, when executed by one or more processors, cause the one or more processors to perform operations comprising:
passing first sensor information received from one or more cognitive input devices through a polysift layer of a neural network to assign a preliminary meaning to individual sensor waveforms from each of the one or more cognitive input devices;
passing the preliminary meaning to a datasift layer of the neural network to determine intent by analyzing information fragment combinations against a linguistic model;
validating accuracy of data generated by the polysift layer and the datasift layer using a deep learning orchestration base of the neural network; and
causing an operations dialer to:
obtain one or more organization processes corresponding to a first user;
extract one or more workflows having steps and entities upon which the steps are performed, from the organization processes;
identify likely user selections based upon the intent; and
generate a screen of a user interface with likely user selections.

16. The non-transitory machine-readable medium of claim 15, wherein the deep learning orchestration base comprises a large language model (LLM).

17. The non-transitory machine-readable medium of claim 15, wherein the steps and entities that the first user is likely to select are identified based on usage history of a plurality of users.

18. The non-transitory machine-readable medium of claim 15, wherein the steps and entities that the first user is likely to select are identified based on usage history of the first user.

19. The non-transitory machine-readable medium of claim 15, wherein the neural network further comprises a pre-datasift layer designed to filter out noise from waveforms from the one or more cognitive input devices.

20. The non-transitory machine-readable medium of claim 15, wherein the one or more cognitive input devices comprise an Electroencephalogram.
